(19) United States
(12) Patent Application Publication
(10) Pub. No.: US 2018/0150061 A1
(43) Pub. Date: May 31, 2018

(54) SYSTEM AND METHOD FOR USING BLUETOOTH COMMUNICATION IN INDUSTRIAL PROCESS CONTROL AND AUTOMATION SYSTEMS

(71) Applicant: Honeywell International Inc., Morris Plains, NJ (US)

(72) Inventors: Zhi Yang, Shanghai (CN); Haifeng Liang, Shanghai (CN); Longfei Chen, Shanghai (CN); Lei Zou, Shanghai (CN)

(21) Appl. No.: 15/362,078

(22) Filed: Nov. 28, 2016

(51) Int. Cl. G05B 19/414; H04W 4/00; H04W 76/02; G05B 19/05

(52) U.S. Cl. CPC G05B 19/414; H04W 4/008; G05B 2219/1209; G05B 19/054; G05B 2219/15117; H04W 76/02

(57) ABSTRACT

A method includes wirelessly connecting to one or more controllers using a BLUETOOTH communication protocol, where the one or more controllers have a BLUETOOTH adapter or transceiver. The method also includes sending a command or data to a first controller among the one or more controllers using the BLUETOOTH communication protocol. The method further includes receiving, from the first controller or a second controller among the one or more controllers using the BLUETOOTH communication protocol, a response associated with the sent command or data. Each of the one or more controllers includes a programmable logic controller (PLC) in an industrial process control and automation system.

### TECHNICAL FIELD

This disclosure relates generally to industrial process control and automation systems. More specifically, this disclosure relates to a system and method for using BLUETOOTH communication in industrial process control and automation systems.

### BACKGROUND

Industrial process control and automation systems are often used to automate large and complex industrial processes. These types of systems routinely include various components including sensors, actuators, and controllers. Some of the controllers can receive measurements from the sensors and generate control signals for the actuators.

Process control and automation systems typically have hardware components participating in control and input/output (I/O) functions that are installed in control rooms. These systems are often used to gather I/O information from the field, which is transmitted to the control rooms. The systems in the control rooms can perform various control functions and transmit outputs back to the field. At various times, the system components in the control rooms can be tested and configured for correct operation. Due to the large number of components in some control rooms, testing and configuration can be very time consuming.

### SUMMARY

This disclosure provides a system and method for using BLUETOOTH communication in industrial process control and automation systems.

In a first embodiment, a method includes wirelessly connecting to one or more controllers using a BLUETOOTH communication protocol, where the one or more controllers have a BLUETOOTH adapter or transceiver. The method also includes sending a command or data to a first controller among the one or more controllers using the BLUETOOTH communication protocol. The method further includes receiving, from the first controller or a second controller among the one or more controllers using the BLUETOOTH communication protocol, a response associated with the sent command or data. Each of the one or more controllers includes a programmable logic controller (PLC) in an industrial process control and automation system.

In a second embodiment, an apparatus includes at least one network interface and at least one processing device. The at least one network interface is configured to wirelessly connect to one or more controllers over a BLUETOOTH network and receive data from and transmit data to the one or more controllers using a BLUETOOTH communication protocol. Each of the one or more controllers includes a PLC in an industrial process control and automation system. Each of the one or more controllers has a BLUETOOTH adapter or transceiver. The at least one processing device is configured to send a command or data to a first controller among the one or more controllers using the BLUETOOTH communication protocol. The at least one processing device is also configured to receive, from the first controller or a second controller among the one or more controllers using the BLUETOOTH communication protocol, a response associated with the sent command or data.

In a third embodiment, a controller includes a BLUETOOTH adapter or transceiver configured to wirelessly connect to a wireless handheld device over a BLUETOOTH network and receive data from and transmit data to the wireless handheld device using a BLUETOOTH communication protocol. The controller also includes at least one processing device configured to receive a command or data from the wireless handheld device using the BLUETOOTH communication protocol. The at least one processing device is also configured to generate a message based on the received command or data. The at least one processing device is further configured to transmit the message to the wireless handheld device or a second controller. The controller and the second controller include PLCs in an industrial process control and automation system.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates a portion of an example industrial process control and automation system according to this disclosure;

FIG. 2 illustrates additional details of a portion of an example industrial process and automation system according to this disclosure;

FIGS. 3A and 3B illustrate example systems for communicating with a BLUETOOTH-enabled industrial process controller according to this disclosure;

FIG. 4 illustrates an example device for performing diagnostic and configuration operations in a process control and automation system according to this disclosure; and

FIG. 5 illustrates an example method for performing diagnostic and configuration operations in a process control and automation system according to this disclosure.

### DETAILED DESCRIPTION

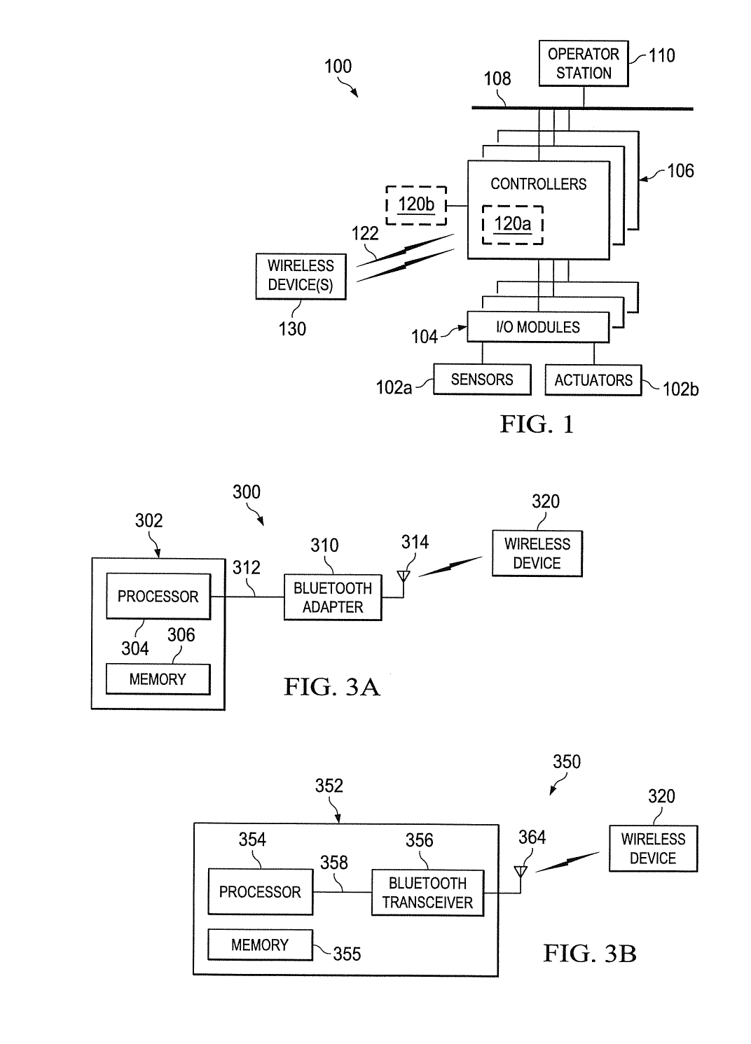

FIGS. 1 through 5, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates a portion of an example industrial process control and automation system 100 according to this disclosure. As shown in FIG. 1, the system 100 includes various components that facilitate production or processing of at least one product or other material. For instance, the system 100 can be used to facilitate control or monitoring of components in one or multiple industrial plants. Each plant represents one or more processing facilities (or one or more portions thereof), such as one or more manufacturing facilities for producing at least one product or other material. In general, each plant may implement one or more industrial processes and can individually or collectively be referred to as a process system. A process system generally represents any system or portion thereof configured to process one or more products or other materials or energy in different forms in some manner.

In the example shown in FIG. 1, the system 100 includes one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. Each of the sensors 102a includes any suitable structure for measuring one or more characteristics in a process system. Each of the actuators 102b includes any suitable structure for operating on or affecting one or more conditions in a process system.

At least one input/output (I/O) module 104 is coupled to the sensors 102a and actuators 102b. The I/O modules 104 facilitate interaction with the sensors 102a, actuators 102b, or other field devices. For example, an I/O module 104 could be used to receive one or more analog inputs (AIs), digital inputs (DIs), digital input sequences of events (DISOEs), or pulse accumulator inputs (PIs) or to provide one or more analog outputs (AOs) or digital outputs (DOs). Each I/O module 104 includes any suitable structure(s) for receiving one or more input signals from or providing one or more output signals to one or more field devices.

The system 100 also includes various controllers 106. The controllers 106 can be used in the system 100 to perform various functions in order to control one or more industrial processes. For example, a first set of controllers 106 may use measurements from one or more sensors 102a to control the operation of one or more actuators 102b. These controllers 106 could interact with the sensors 102a, actuators 102b, and other field devices via the I/O module(s) 104. A second set of controllers 106 could be used to optimize the control logic or other operations performed by the first set of controllers. A third set of controllers 106 could be used to perform additional functions.

Controllers 106 are often arranged hierarchically in a system. For example, different controllers 106 could be used to control individual actuators, collections of actuators forming machines, collections of machines forming units, collections of units forming plants, and collections of plants forming an enterprise. A particular example of a hierarchical arrangement of controllers 106 is defined as the “Purdue” model of process control. The controllers 106 in different hierarchical levels can communicate via one or more networks 108 and associated switches, firewalls, and other components.

Each controller 106 includes any suitable structure for controlling one or more aspects of an industrial process. At least some of the controllers 106 could, for example, represent proportional-integral-derivative (PID) controllers or multivariable controllers, such as Robust Multivariable Predictive Control Technology (RMPCT) controllers or other types of controllers implementing model predictive control (MPC) or other advanced predictive control. As a particular example, each controller 106 could represent a computing device running a real-time operating system, a WINDOWS operating system, or other operating system.

Operator access to and interaction with the controllers 106 and other components of the system 100 can occur via various operator stations 110. Each operator station 110 could be used to provide information to an operator and receive information from an operator. For example, each operator station 110 could provide information identifying a current state of an industrial process to an operator, such as values of various process variables and warnings, alarms, or other states associated with the industrial process. Each operator station 110 could also receive information affecting how the industrial process is controlled, such as by receiving setpoints for process variables controlled by the controllers 106 or other information that alters or affects how the controllers 106 control the industrial process. Each operator station 110 includes any suitable structure for displaying information to and interacting with an operator. Multiple operations stations 110 are often collected into one or more control rooms.

This represents a brief description of one type of industrial process control and automation system that may be used to manufacture or process one or more materials. Additional details regarding industrial process control and automation systems are well-known in the art and are not needed for an understanding of this disclosure. Also, industrial process control and automation systems are highly configurable and can be configured in any suitable manner according to particular needs.

In particular embodiments, the various controllers and operator stations in FIG. 1 may represent computing devices. For example, each of the controllers and operator stations could include one or more processing devices and one or more memories for storing instructions and data used, generated, or collected by the processing device(s). Each of the controllers and operator stations could also include at least one network interface, such as one or more Ethernet interfaces or wireless transceivers.

In process control and automation systems such as the system 100, it is often necessary or desirable to perform diagnostic and configuration activities on various components, such as controllers, I/O modules, and I/O channels. For example, it may be necessary to check communication connections between components installed in different racks, verify system redundancy properties, check I/O channel statuses, calibrate or configure components, perform system upgrades, and the like. In typical systems, these types of activities are often performed using a handheld device that is physically connected to each component one at a time using a wired connection. Once one component has been tested or configured, the handheld device is unplugged from the component, moved to another component, and attached to the other component for testing or configuration. This is a process that is very time consuming and laborious.

In accordance with this disclosure, various components in the system 100 are designed or modified to support a BLUETOOTH communication connection with a wireless handheld device 130, such as a laptop computer, tablet computer, smartphone, or other portable device. For example, one or more of the controllers 106 could include an integrated BLUETOOTH transceiver 120a. As another example, one or more of the controllers 106 could be coupled to a standalone BLUETOOTH adapter 120b. The BLUETOOTH transceiver 120a or BLUETOOTH adapter 120b allows the controller(s) 106 to communicate over a BLUETOOTH communication link 122 with the wireless handheld device 130. The wireless handheld device 130 is configured to perform diagnostic and configuration activities on the controller(s) 106 over the BLUETOOTH communication link 122. The wireless BLUETOOTH communication link 122 solves problems associated with manually establishing a wired connection to each controller 106 before performing any diagnostic and configuration activities on the controller(s) 106. Additional details regarding this functionality are provided below.

Although FIG. 1 illustrates one example of an industrial process control and automation system 100, various changes may be made to FIG. 1. For example, the system 100 could include any number of sensors, actuators, I/O modules, controllers, operator stations, networks, BLUETOOTH transceivers, BLUETOOTH adapters, wireless handheld devices, and other components. Also, the makeup and arrangement of the system 100 in FIG. 1 are for illustration only. Components could be added, omitted, combined, or placed in any other suitable configuration according to particular needs. Further, particular functions have been described as being performed by particular components of the system 100. This is for illustration only. In general, control and automation systems are highly configurable and can be configured in any suitable manner according to particular needs. In addition, FIG. 1 illustrates one example operational environment in which a wireless handheld device can communicate over a BLUETOOTH communication link with a controller in order to perform diagnostic and configuration activities on the controller. This functionality can be used in any other suitable system.

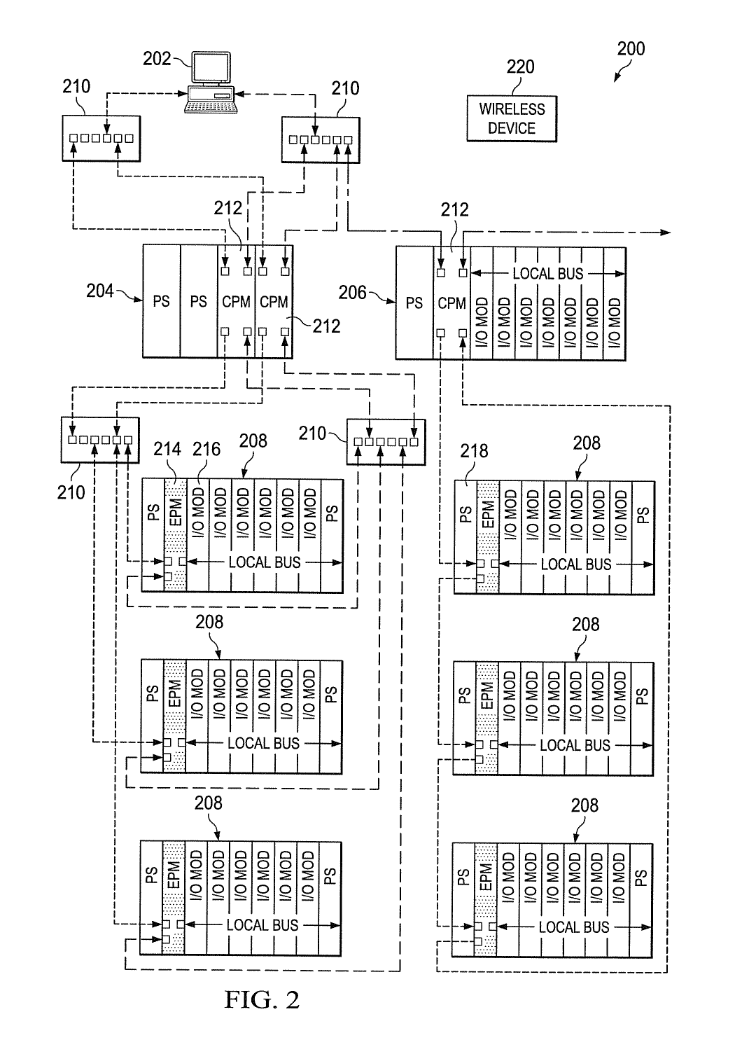

FIG. 2 illustrates additional details of a portion of an example industrial process and automation system 200 according to this disclosure. Many of the components shown in FIG. 2 may represent or be represented by corresponding components of the system 100 of FIG. 1. However, the system 200 could be used as part of any other suitable system.

As shown in FIG. 2, the system 200 includes various portions of a programmable logic controller (PLC) system. The components include one or more operator stations 202, a redundancy rack 204, a non-redundancy rack 206, multiple expansion I/O racks 208, and multiple switches or routers 210.

Each operator station 202 could be used to provide information to and receive information from an operator. For example, the operator station 202 could operate in a manner similar to one or more of the operator stations 110 of FIG. 1. As particular examples, each operator station 202 could provide information identifying a current state of an industrial process to an operator and receive information affecting how the industrial process is controlled. Each operator station 202 includes any suitable structure for displaying information to and interacting with an operator.

The racks 204-208 represent electronic component racks or cabinets having shelves and slots or other structures for installation of electronic components. In this example, each rack 204-206 includes one or more control processor modules (CPMs) 212. In particular, the redundancy rack 204 is configured for hardware redundancy and includes multiple CPMs 212, while the non-redundancy rack 206 is not configured for hardware redundancy and includes only one CPM 212. Each expansion I/O rack 208 includes an expansion processor module (EPM) 214. Depending on the configuration, each rack 204-208 includes zero, one, or multiple I/O modules 216. In this example, the redundancy rack 204 does not include any I/O modules 216, and the non-redundancy rack 206 and the expansion I/O racks 208 include multiple I/O modules 216. Common rack installations may include four, eight, or twelve I/O modules 216, although other numbers of I/O modules 216 are possible. Each rack 204-208 also includes one or more power supplies 218 for providing power to the rack 204-208 or to the components installed in the rack 204-208. The redundancy rack 204 includes multiple power supplies 218 in order to provide power redundancy.

The CPMs 212 and EPMs 214 are PLC controllers and may represent or be represented by the controllers 106 of FIG. 1. The CPMs 212 and EPMs 214 perfoi in various functions for control of one or more industrial processes. For example, the CPMs 212 or EPMs 214 may use measurements from one or more sensors (such as the sensors 102a) to control the operation of one or more actuators (such as the actuators 102b). These CPMs 212 and EPMs 214 could interact with the sensors, actuators, and other field devices via the I/O modules 216.

The CPMs 212 are considered “local” controllers and represent initial controllers installed for operation of a process control and automation system. In the “local” redundancy rack 204, one of the CPMs 212 is considered the primary controller, while the other CPM 212 is considered the secondary controller. In the “local” non-redundancy rack 206, there is only one CPM 212, so it is not considered primary or secondary. If a process control and automation system is large and requires expansion beyond the capacity of the local CPMs 212, one or more EPMs 214 can be installed and configured in the expansion I/O racks 208 to provide expanded capability in the process control and automation system, such as shown in the system 200. The CPMs 212 and EPMs 214 are configured to form a network, such as an Ethernet network. Traffic between the CPMs 212 and EPMs 214 can be controlled by the switches or routers 210.

As described earlier, the CPMs 212 and EPMs 214 may periodically require configuration and diagnostic operations in order to ensure optimal overall performance of the system 200. For example, it is expected that an operator (such as a system engineer) be able to connect to the CPMs 212 and EPMs 214 to perform various configuration and diagnostic operations. Example operations may include:

Checking communication connections between components on different racks.

Safely forcing a redundancy switchover.

Checking I/O channel states on local or expansion racks and performing single-step execution of applications.

Performing on-field calibration for AI and AO channels.

Performing bulk configuration for components that have the same configuration.

Performing firmware upgrades.

Checking system event logs for any issue analysis.

These types of operations are pervasive in PLC systems. To facilitate these operations, one or more of the CPMs 212 and EPMs 214 can be configured for BLUETOOTH communication with a wireless handheld device 220 (such as a laptop computer, tablet computer, smartphone, or other portable device) used by an operator. For example, the CPMs 212 and EPMs 214 can be configured as shown in FIGS. 3A and 3B, which are discussed in detail below. The BLUETOOTH capability allows easy communication with the wireless handheld device 220 without the need to establish a wired connection with each CPM 212 and EPM 214.

Although FIG. 2 illustrates one example of a system 200 in which BLUETOOTH communication can be used, various changes may be made to FIG. 2. For example, various components in FIG. 2 could be combined, further subdivided, or omitted and additional components could be added according to particular needs. Also, process control and automation systems can come in a wide variety of configurations, and FIG. 2 does not limit this disclosure to any particular configuration. In addition, FIG. 2 illustrates another example operational environment in which a wireless handheld device can communicate over a BLUETOOTH communication link with a controller in order to perform diagnostic and configuration activities on the controller. This functionality can be used in any other suitable system.

FIGS. 3A and 3B illustrate example systems 300, 350 for communicating with a BLUETOOTH-enabled industrial process controller according to this disclosure. Specifically, FIG. 3A illustrates a system 300 in which a controller 302 is connected to a BLUETOOTH adapter 310, while FIG. 3B illustrates a system 350 in which a controller 352 includes an integrated BLUETOOTH transceiver 356. As known in the art, BLUETOOTH refers to a wireless protocol in which data is exchanged between paired devices over short distances using short wavelength UHF radio waves in a band from 2.4 to 2.485 GHz. Many of the components shown in FIGS. 3A and 3B may represent or be represented by corresponding components of the systems 100, 200 of FIGS. 1 and 2. However, the systems 300, 350 could be used as part of any other suitable larger system.

As shown in FIG. 3A, the system 300 includes a PLC controller 302, which may represent or be represented by one of the controllers 106 of FIG. 1 or one of the CPMs 212 or EPMs 214 of FIG. 2. The controller 302 includes a processor 304 and a memory 306. The processor 304 controls operations of the controller 302 and specifically controls the BLUETOOTH adapter 310 to transmit and receive signals by sending digital or analog control signals to the BLUETOOTH adapter 310. The processor 304 denotes any suitable processing device, such as one or more microprocessors, microcontrollers, digital signal processors (DSPs), field programmable gate arrays (FPGAs), application specific integrated circuits (ASICs), or discrete circuitry. The memory 306 represents any structure(s) capable of storing and facilitating retrieval of information (such as data, program code, and/or other suitable information on a temporary or permanent basis) and may represent a random access memory, read only memory, or any other suitable volatile or non-volatile storage device(s).

The BLUETOOTH adapter 310 is coupled to the controller 302 using a wired communication link 312, such as a universal asynchronous receiver/transmitter (UART) interface or serial peripheral interface (SPI). The BLUETOOTH adapter 310 includes an antenna 314 for transmission and reception of BLUETOOTH signals, such as signals transmitted to or received from a wireless handheld device 320, such as a laptop computer, tablet computer, smartphone, or other portable device. The BLUETOOTH adapter 310 has a device identifier (ID) and a media access control (MAC) address that are recorded in the memory 306. The BLUETOOTH adapter 310 could be the same as or similar to the BLUETOOTH adapter 120b of FIG. 1.

As shown in FIG. 3B, the system 350 includes a PLC controller 352, which may represent or be represented by one of the controllers 106 of FIG. 1 or one of the CPMs 212 and EPMs 214 of FIG. 2. The controller 352 includes a processor 354 and a memory 355. The processor 354 controls operations of the controller 352 and specifically controls the BLUETOOTH transceiver 356 to transmit and receive signals by sending digital or analog control signals to the BLUETOOTH transceiver 356. The processor 354 denotes any suitable processing device, such as one or more microprocessors, microcontrollers, DSPs, FPGAs, ASICs, or discrete circuitry. The memory 355 represents any structure(s) capable of storing and facilitating retrieval of information (such as data, program code, and/or other suitable information on a temporary or permanent basis), and may represent a random access memory or any other suitable volatile or non-volatile storage device(s).

The BLUETOOTH transceiver 356 is coupled to the processor 354 using a hardware interface 358. The BLUETOOTH transceiver 356 is integrated in the controller 352 and, in some embodiments, can be mounted to the same circuit board (such as a printed circuit board) as the processor 354. In other embodiments, the BLUETOOTH transceiver 356 can be disposed on a daughter board that is included in or added to the controller 352 or implemented in any other suitable manner. The BLUETOOTH transceiver 356 includes an antenna 364 for transmission and reception of BLUETOOTH signals, such as signals transmitted to or received from a wireless handheld device 320. The BLUETOOTH transceiver 356 has a device ID and MAC address that are recorded on in a memory 355 (such as a nonvolatile memory chip) in the controller 352. The BLUETOOTH transceiver 356 could be the same as or similar to the BLUETOOTH transceiver 120a of FIG. 1.

In addition to including hardware components that support BLUETOOTH communication, both the controllers 302, 352 and the wireless device 320 can include software or firmware modules that support BLUETOOTH communication. This can include one or more applications, functions, or programs for searching for, identifying, authorizing, and pairing devices for BLUETOOTH communication. Specifically, the controllers 302, 352 can be configured to identify BLUETOOTH partner devices and grant such devices authority for access.

In one aspect of operation, BLUETOOTH communication between the wireless device 320 and the controller 302, 352 is established according to the following procedure. First, the controller 302, 352 broadcasts an identification signal when idle. The identification signal includes a device ID. At the same time, the wireless device 320 listens for an identification signal from a controller. After finding the specific controller 302, 352 by detecting its identification signal, the wireless device 320 sends a link request to the controller 302, 352. The controller 302, 352 identifies the wireless device 320 by the link request and performs an authorization operation to determine if the controller 302, 352 can connect to the wireless device 320.

In some embodiments, a pair of keys—a private key and a corresponding public key—is used to perform the authorization. The public key is stored in the controller 302, 352. A specified calculation result based on the device ID of the controller 302, 352, a device ID of the wireless device 320, a PIN code or other value, and the corresponding private key is generated by the wireless device 320. If the wireless device 320 attempts to connect to the controller 302, 352, the controller 302, 352 receives the device ID of the wireless device 320 and the private key. The controller 302, 352 uses its public key to calculate the private key and compare it with the calculation result from the wireless device 320. If both values are the same, the wireless device 320 would be considered authorized, and the controller 302, 352 and the wireless device 320 can “pair” or connect.

After the controller 302, 352 and the wireless device 320 are paired, the wireless device 320 can send various commands or data to the controller 302, 352, and the controller 302, 352 can respond by performing one or more operations, sending one or more responses to the wireless device 320, or both. In some embodiments, the wireless device 320 can support multiple BLUETOOTH connections (pair with multiple controllers 302, 352) in order to perform diagnostic and configuration operations of two or more controllers 302, 352 simultaneously.

Although FIGS. 3A and 3B illustrate two examples of systems 300, 350 for communicating with a BLUETOOTH-enabled industrial process controller, various changes may be made to FIGS. 3A and 3B. For example, the makeup and arrangement of the systems 300, 350 in FIGS. 3A and 3B are for illustration only. Components could be added, omitted, combined, or placed in any other suitable configuration according to particular needs. Also, particular functions have been described as being performed by particular components of the systems 300, 350. This is for illustration only. In general, wireless communication systems are highly configurable and can be configured in any suitable manner according to particular needs.

Any one or more of the following diagnostic and configuration operations can be performed using the embodiments described in this patent document. For example, these operations can be performed by the system 100 of FIG. 1 or the system 200 of FIG. 2 having one or more controllers and wireless devices configured as described in FIG. 3A or 3B.

In a first operation, a wireless handheld device 220 can check the communication connection between two controllers installed on different racks. First, the wireless device 220 establishes a BLUETOOTH connection to two controllers at the same time, such as a CPM 212 on the redundancy rack 204 and the CPM 212 on the non-redundancy rack 206. The wireless device 220 sends a command, such as a ping command or a “connection check” command, to the first CPM 212 over the BLUETOOTH connection. When the first CPM 212 receives the command, the first CPM 212 sends a message, such as one or more broadcast frames, to the second CPM 212. When the second CPM 212 receives the message from the first CPM 212, the second CPM 212 sends a confirmation message to the wireless device 220 over the BLUETOOTH connection. The confirmation message indicates that the second CPM 212 successfully received the message from the first CPM 212. When the wireless device 220 receives the confirmation message from the second CPM 212, the wireless device 220 indicates to a user (via a displayed message, an audible sound, or the like) that the communication connection between the first CPM 212 and the second CPM 212 is working.

In a second operation, the wireless device 220 can safely force a redundancy switchover between redundant controllers. First, the wireless device 220 establishes a BLUETOOTH connection to two redundant controllers at the same time, such as the primary CPM 212 on the redundancy rack 204 and the secondary CPM 212 on the redundancy rack 204. The wireless device 220 sends a switchover command to the primary CPM 212 over the BLUETOOTH connection. When the primary CPM 212 receives the command, the primary CPM 212 determines if the secondary CPM 212 can take over as primary by exchanging one or more switchover messages with the secondary CPM 212. If so, the primary and secondary CPMs 212 switch roles, and one of the CPMs 212 sends a confirmation message of a successful switchover to the wireless device 220. If the primary and secondary CPMs 212 cannot safely switch roles, one of the CPMs 212 sends a message to the wireless device 220 that indicates that a switchover did not or cannot occur.

In a third operation, the wireless device 220 can check I/O channel states on a local rack or an expansion rack by performing single-step execution of user-defined control logic installed on a controller. The user-defined control logic can be developed by a customer or end-user and installed on a controller in order to provide customized operation of the controller or I/O channels. First, the wireless device 220 establishes a BLUETOOTH connection to a controller having the user-defined control logic, such as one of the CPMs 212 or EPMs 214, while the controller is in a “not running” state. The wireless device 220 then sends one or more control commands to control the CPM 212 or EPM 214 to execute the user-defined control logic one step at a time in order to test or debug the control logic or the operation of each I/O channel. Normally, such user-defined control logic is automatically executed and executes without interruption. In contrast, step-by-step execution allows the wireless device 220 to check parameter values and troubleshoot at intermediate points during the execution. After each step of execution, the CPM 212 or EPM 214 can send configuration information, data, parameters, or other values output by the user-defined control logic to the wireless device 220 over the BLUETOOTH connection.

In a fourth operation, the wireless device 220 can perform on-field calibration for one or more AI or AO channels associated with a controller. First, the wireless device 220 establishes a BLUETOOTH connection to a controller having an associated AI or AO channel, such as one of the CPMs 212 or EPMs 214, while the controller is in a “not running” state. The wireless device 220 then sends a command to the CPM 212 or EPM 214 to read an AI value from an AI channel or write an AO value to an AO channel. In some embodiments, the sent command can include the desired AO value. The CPM 212 or EPM 214 can send a confirmation message to the wireless device 220. In some embodiments, the confirmation message can include the read AI value or an indication that the AO was successfully written.

In a fifth operation, the wireless device 220 can perform a bulk configuration in which configuration information is quickly distributed to multiple controllers. First, the wireless device 220 obtains one or more controller configuration files and stores the file(s) in a memory. Such files can be quite large. The wireless device 220 then establishes a BLUETOOTH connection to a controller, such as one of the CPMs 212 or EPMs 214, while the controller is in a “program” state. The wireless device 220 copies the configuration file(s) to the CPM 212 or EPM 214. Once the configuration file(s) are successfully copied, the CPM 212 or EPM 214 sends a confirmation message to the wireless device 220 indicating that the copy was successfully completed. At that point, the wireless device 220 can close the BLUETOOTH connection to the CPM 212 or EPM 214, establish a BLUETOOTH connection to another controller, and copy the same configuration file(s) to that controller without having to reload the configuration file(s). This process can be repeated for as many controllers as require configuration.

In a sixth operation, the wireless device 220 can check the firmware for each of multiple controllers and perform a firmware upgrade on any controller that has an outdated version. First, the wireless device 220 establishes a BLUETOOTH connection to a controller, such as one of the CPMs 212 or EPMs 214, while the controller is in an “idle” state. The wireless device 220 obtains firmware and hardware status information from the CPM 212 or EPM 214, such as by sending a status request command and receiving a status message over the BLUETOOTH connection. If the firmware of the CPM 212 or EPM 214 is outdated, the wireless device 220 can transfer one or more new firmware image files to the CPM 212 or EPM 214 over the BLUETOOTH connection. Once the firmware image file(s) are successfully copied, the CPM 212 or EPM 214 sends a confirmation message to the wireless device 220 indicating that the copy was successfully completed.

In a seventh operation, the wireless device 220 can check one or more system event logs stored at a controller and configured to log events at the controller. First, the wireless device 220 establishes a BLUETOOTH connection to a controller, such as one of the CPMs 212 or EPMs 214. Then, the wireless device 220 sends a command over the BLUETOOTH connection to the CPM 212 or EPM 214 to export one or more system event logs associated with the CPM 212 or EPM 214. The CPM 212 or EPM 214 receives the command and, in response, prepares the event log data for a time period and transfers the event log data to the wireless device 220.

While the foregoing diagnostic and configuration operations are referred to as first through seventh operations, such reference is merely to distinguish between the different operations and does not represent any preferred or required order. Moreover, such operations are representative examples and are not limiting. Other or additional operations using a BLUETOOTH connection may also be performed within the scope of this disclosure.

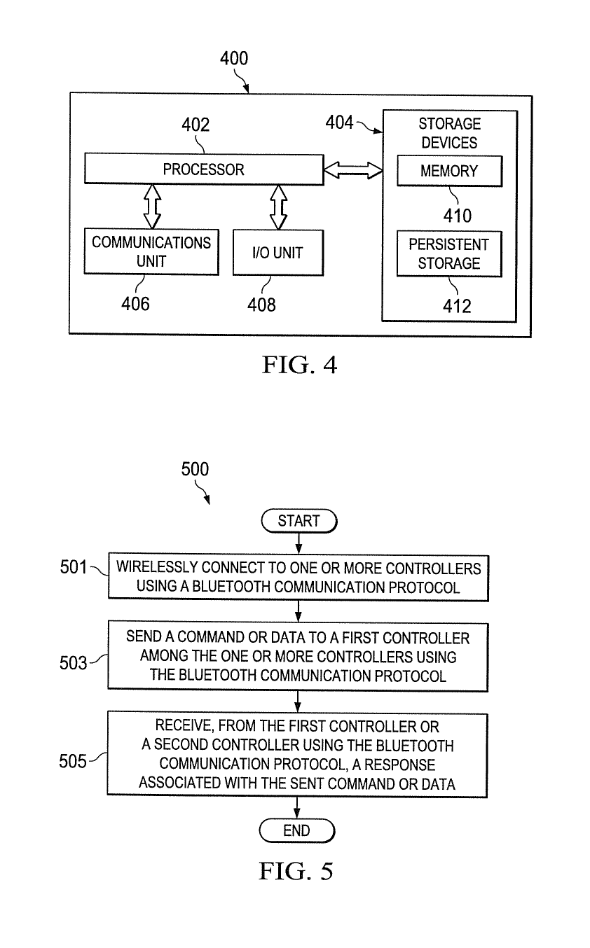

FIG. 4 illustrates an example device 400 for performing diagnostic and configuration operations in a process control and automation system according to this disclosure. The device 400 could, for example, represent any of the wireless handheld devices 130, 220, or 320. However, the device 400 could represent any other suitable device or components for performing diagnostic and configuration operations in a process control and automation system.

As shown in FIG. 4, the device 400 includes at least one processor 402, at least one storage device 404, at least one communications unit 406, and at least one input/output (I/O) unit 408. Each processor 402 can execute instructions, such as those that may be loaded into a memory 410. Each processor 402 denotes any suitable processing device, such as one or more microprocessors, microcontrollers, DSPs, FPGAs, ASICs, or discrete circuitry.

The memory 410 and a persistent storage 412 are examples of storage devices 404, which represent any structure(s) capable of storing and facilitating retrieval of information (such as data, program code, and/or other suitable information on a temporary or permanent basis). The memory 410 may represent a random access memory or any other suitable volatile or non-volatile storage device(s). The persistent storage 412 may contain one or more components or devices supporting longer-term storage of data, such as a read only memory, hard drive, Flash memory, or optical disc.

The communications unit 406 supports communications with other systems or devices. For example, the communications unit 406 could include at least one network interface card or wireless transceiver facilitating communications over at least one wired or wireless network. As a particular example, in accordance with this disclosure, the communications unit 406 could include any suitable structure and components to support BLUETOOTH communication over a BLUETOOTH wireless network. The communications unit 406 may support communications through any suitable physical or wireless communication link(s).

The I/O unit 408 allows for input and output of data. For example, the I/O unit 408 may provide a connection for user input through a keyboard, mouse, keypad, touchscreen, or other suitable input device. The I/O unit 408 may also send output to a display, printer, or other suitable output device.

Although FIG. 4 illustrates one example of a device 400 for performing diagnostic and configuration operations in a process control and automation system, various changes may be made to FIG. 4. For example, various components in FIG. 4 could be combined, further subdivided, or omitted and additional components could be added according to particular needs. Also, computing devices can come in a wide variety of configurations, and FIG. 4 does not limit this disclosure to any particular configuration.

FIG. 5 illustrates an example method 500 for performing diagnostic and configuration operations in a process control and automation system according to this disclosure. For ease of explanation, the method 500 is described as being performed using the system 100 of FIG. 1 or the system 200 of FIG. 2 having one or more controllers and wireless devices configured as described in FIG. 3A or 3B. However, the method 500 could be used with any suitable device or system.

A wireless handheld device wirelessly connects to one or more controllers using a BLUETOOTH communication protocol at step 501. Each of the controllers could be a PLC in an industrial process control and automation system. This could include, for example, the wireless device 220 connecting to one or more of the CPMs 212 or the EPMs 214. The controller(s) have a BLUETOOTH adapter (such as the BLUETOOTH adapter 310) or transceiver (such as the BLUETOOTH transceiver 356) to make the BLUETOOTH connection possible.

The wireless handheld device sends a command or data to a first controller among the one or more controllers using the BLUETOOTH communication protocol at step 503. This could include, for example, the wireless device 220 sending a command or data to one of the CPMs 212 or the EPMs 214. In some embodiments, the sent command or data could include a communication check command for determining a communication status between two controllers, a redundancy switchover command for switching between primary and secondary controllers, a control command to execute user-defined control logic one step at a time, a command to read an AI value from an AI channel associated with the controller or write an AO value to an AO channel associated with the controller, one or more controller configuration files or firmware upgrade files to be copied to the controller, or a command to export one or more system event logs associated with the controller.

At step 505, the wireless handheld device receives a response associated with the sent command or data from the first controller or a second controller among the one or more controllers. The response is received using the BLUETOOTH communication protocol. This could include the wireless device 220 receiving a response from one of the CPMs 212 or the EPMs 214. In some embodiments, the received response could be data or information requested during the operation, or could be a confirmation that a previous operation was successful.

Although FIG. 5 illustrates one example of a method 500 for performing diagnostic and configuration operations in a process control and automation system, various changes may be made to FIG. 5. For example, while shown as a series of steps, various steps shown in FIG. 5 could overlap, occur in parallel, occur in a different order, or occur multiple times. Moreover, some steps could be combined or removed and additional steps could be added according to particular needs. In addition, while the method 500 is described with respect to the systems 100, 200 (which were described with respect to an industrial process control and automation system), the method 500 may be used in conjunction with other types of devices and systems.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
wirelessly connecting to one or more controllers using a BLUETOOTH communication protocol, the one or more controllers having a BLUETOOTH adapter or transceiver;
sending a command or data to a first controller among the one or more controllers using the BLUETOOTH communication protocol; and
receiving, from the first controller or a second controller among the one or more controllers using the BLUETOOTH communication protocol, a response associated with the sent command or data;
wherein each of the one or more controllers comprises a programmable logic controller (PLC) in an industrial process control and automation system.

2. The method of claim 1, wherein:
the sent command or data comprises a communication check command for determining a communication status between the first controller and the second controller; and
the received response is received from the second controller and comprises a confirmation of successful communication between the first controller and the second controller.

3. The method of claim 1, wherein:
the first controller is a primary controller and the second controller is a secondary controller;
the sent command or data comprises a redundancy switchover command for switching the secondary controller to primary and switching the primary controller to secondary; and
the received response is received from the second controller and comprises a confirmation of successful switchover.

4. The method of claim 1, wherein:
the sent command or data comprises one or more control commands to execute user-defined control logic one step at a time; and
the received response is received from the first controller and comprises data output by the user-defined control logic during each step of execution.

5. The method of claim 1, wherein:
the sent command or data comprises a command to read an analog input (AI) value from an AI channel associated with the first controller or write an analog output (AO) value to an AO channel associated with the first controller; and
the received response is received from the first controller and comprises the read AI value or an indication that the AO was successfully written.

6. The method of claim 1, wherein:
the one or more controllers comprise a plurality of controllers;
the sent command or data comprises one or more controller configuration files or one or more firmware upgrade files to be copied to each controller; and
the received response is received from the first controller and comprises a confirmation that a copy to the first controller was successfully completed.

7. The method of claim 1, wherein:
the sent command or data comprises a command to export one or more system event logs associated with the first controller; and
the received response is received from the first controller and comprises event log data associated with the controller.

8. An apparatus comprising:
at least one network interface configured to wirelessly connect to one or more controllers over a BLUETOOTH network and receive data from and transmit data to the one or more controllers using a BLUETOOTH communication protocol, each of the one or more controllers comprising a programmable logic controller (PLC) in an industrial process control and automation system, each of the one or more controllers having a BLUETOOTH adapter or transceiver; and
at least one processing device configured to:
send a command or data to a first controller among the one or more controllers using the BLUETOOTH communication protocol; and
receive, from the first controller or a second controller among the one or more controllers using the BLUETOOTH communication protocol, a response associated with the sent command or data.

9. The apparatus of claim 8, wherein:
the sent command or data comprises a communication check command for determining a communication status between the first controller and the second controller; and
the received response is received from the second controller and comprises a confirmation of successful communication between the first controller and the second controller.

10. The apparatus of claim 8, wherein:
the first controller is a primary controller and the second controller is a secondary controller;
the sent command or data comprises a redundancy switchover command for switching the secondary controller to primary and switching the primary controller to secondary; and
the received response is received from the second controller and comprises a confirmation of successful switchover.

11. The apparatus of claim 8, wherein:
the sent command or data comprises one or more control commands to execute user-defined control logic one step at a time; and
the received response is received from the first controller and comprises data output by the user-defined control logic during each step of execution.

12. The apparatus of claim 8, wherein:
the sent command or data comprises a command to read an analog input (AI) value from an AI channel associated with the first controller or write an analog output (AO) value to an AO channel associated with the first controller; and
the received response is received from the second controller and comprises the read AI value or an indication that the AO was successfully written.

13. The apparatus of claim 8, wherein:
the one or more controllers comprise a plurality of controllers;
the sent command or data comprises one or more controller configuration files or one or more firmware upgrade files to be copied to each controller; and
the received response is received from the first controller and comprises a confirmation that a copy to the first controller was successfully completed.

14. The apparatus of claim 8, wherein:
the sent command or data comprises a command to export one or more system event logs associated with the first controller; and
the received response is received from the first controller and comprises event log data associated with the controller.

15. A controller comprising:
a BLUETOOTH adapter or transceiver configured to wirelessly connect to a wireless handheld device over a BLUETOOTH network and receive data from and transmit data to the wireless handheld device using a BLUETOOTH communication protocol; and
at least one processing device configured to:
receive a command or data from the wireless handheld device using the BLUETOOTH communication protocol;
generate a message based on the received command or data; and
transmit the message to the wireless handheld device or a second controller;
wherein the controller and the second controller comprise programmable logic controllers (PLCs) in an industrial process control and automation system.

16. The controller of claim 15, wherein:
the received command or data comprises a communication check command for determining a communication status between the controller and the second controller; and
the transmitted message comprises one or more broadcast frames sent to the second controller, the transmitted message configured to cause the second controller to send to the wireless handheld device a confirmation of successful communication between the controller and the second controller.

17. The controller of claim 15, wherein:
the controller is a primary controller and the second controller is a secondary controller;
the received command or data comprises a redundancy switchover command for switching the secondary controller to primary and switching the primary controller to secondary; and
the transmitted message comprises a switchover message sent to the second controller.

18. The controller of claim 15, wherein:
the received command or data comprises one or more control commands to execute user-defined control logic installed at the controller one step at a time; and
the transmitted message comprises data output by the user-defined control logic during each step of execution.

19. The controller of claim 15, wherein:
the received command or data comprises a command to read an analog input (AI) value from an AI channel associated with the controller or write an analog output (AO) value to an AO channel associated with the controller; and
the transmitted message comprises the read AI value or an indication that the AO was successfully written.

20. The controller of claim 15, wherein:
the controller is one of a plurality of controllers;
the received command or data comprises one or more controller configuration files or one or more firmware upgrade files to be copied to each of the plurality of controllers; and
the transmitted message comprises a confirmation that a copy was successfully completed.
